(19) United States
(12) Patent Application Publication
(10) Pub. No.: US 2025/0109847 A1
(43) Pub. Date: Apr. 3, 2025

(54) CONNECTING DEVICE AND LAMP

(71) Applicant: Radiant Opto-Electronics Corporation, KAOHSIUNG (TW)

(72) Inventors: Chih-Hung JU, KAOHSIUNG (TW); Chung-Kuang CHEN, KAOHSIUNG (TW); Yi-An LIN, KAOHSIUNG (TW); Guo-Hao HUANG, KAOHSIUNG (TW); Pin-Tsung WANG, KAOHSIUNG (TW)

(21) Appl. No.: 18/666,792

(22) Filed: May 16, 2024

Related U.S. Application Data
(63) Continuation of application No. PCT/CN2023/132605, filed on Nov. 20, 2023.

(30) Foreign Application Priority Data
Sep. 28, 2023 (CN) 2023112693819

(51) Int. Cl. F21V 23/06; F21V 23/02

(52) U.S. Cl. CPC F21V 23/06; F21V 23/02; H01R 13/502; H01R 13/629; H01R 13/641

(57) ABSTRACT

A connecting device used for electrically connecting a power source with a power consuming module is provided. The connecting device includes a female connecting base and a male connecting base. The female connecting base has two opposite surfaces, a rim disposed on one of the surfaces and two terminals exposed on the surfaces. The terminals are connected to the live wire and neutral wire of the power source separately. The male connecting base includes a clamp, two conductive strips, and a ground strip. The rim is clamped, and the male connecting base is fastened to the female connecting base by the clamp. The terminals are connected to the conductive strips, while the end surface of each conductive strip protrudes from the surface of the male connecting base. The ground strip includes a ground surface which protrudes from the end surfaces of the conductive strips.

### RELATED APPLICATIONS

This application is a continuation of International application no. PCT/CN2023/132605, filed Nov. 20, 2023 which claims the benefits of priority of China application no. 2023112693819, filed on Sep. 28, 2023, the content of which are incorporated herein by reference in their entireties.

### BACKGROUND

### Technical field

The present disclosure relates to a connecting device used for electrical connection. More particular, the present disclosure relates to the connecting device which electrically connects a power source and a power consuming module with rotating buckles, and also relates to the lamp including this connecting device.

### Description of Related Art

In response to market demands, the lighting fixtures designs have become more diverse. Among the diversity of lighting fixtures, the installation for ceiling lamp is more challenging. Thus, various types of quick-release mechanisms have been developed to meet the needs of installation for ceiling lamps. Present quick-release mechanism is to fasten the lamp base to the ceiling, and then to buckle the lamp holder which connects to the lamp body to the lamp base with a push buckle. The lamp body may include the light guide plate. However, when the push buckle is disposed on the central position relative to the light guide plate, it is uneasy for the installer to access and operate the push buckle with both hands, so that the lamp is uneasy to be buckled. In other words, once the plug on the lamp base is obstructed by the light guide plate or the lamp body, the installation is hindered. Therefore, push buckles are not suitable for lighting fixtures with exposed light guide plates or for larger and heavier lighting fixtures.

Moreover, most quick-release mechanisms utilize plastic casings, failing to account for proper grounding effect during installation. Thus, the concerns about the electrical safety and reliability during installation are raised. In addition, the plastic casings lack for sufficient strength to support heavier lighting fixtures.

### SUMMARY

Accordingly, an object for the disclosure is to provide a connecting device, and this connecting device may connect a power source and a power consuming module in rapid, thereby improving the convenience and the safety for installation.

At least one embodiment of the disclosure provides a connecting device. This connecting device is used for electrically connecting a power source with a power consuming module and includes a female connecting base having a first surface and a second surface opposite to each other. The female connecting base includes a rim disposed on the first surface and two terminals used for separately connecting to a live wire and a neutral wire of the power source, and the terminals are exposed on the second surface of the female connecting base. The connecting device includes a male connecting base including a clamp used for clamping the rim, and a third surface of the male connecting base faces to the second surface of the female connecting base and is fastened to the female connecting base. Two conductive strips are used for connecting to the terminals of the female connecting base separately, and an end surface of each of the conductive strips protrudes from the third surface of the male connecting base. A ground strip includes a ground surface, and the ground surface protrudes from the end surfaces of the conductive strips.

At least in one embodiment of the disclosure, the female connecting base further includes two first arc recesses opposite to each other and disposed on the second surface. One of the terminals is exposed on a bottom surface of the first arc recesses. Two second arc recesses are opposite to each other and disposed on the second surface, and the other one of the terminals is exposed on a bottom surface of the second arc recesses. The first arc recesses and the second arc recesses are concentric circular arcs, and an arc radius of the second arc recesses is different from an arc radius of the first arc recesses. When the male connecting base is fastened to the female connecting base, the conductive strips of the male connecting base is connected with the terminals of the female connecting base within the first arc recesses and the second arc recesses.

At least in one embodiment of the disclosure, an arc length of the rim extends along an arc length of the first arc recesses.

At least in one embodiment of the disclosure, the female connecting base further includes a structural board located on the second surface and overlapping the rim in the normal direction of the second surface. When the male connecting base is fastened to the female connecting base, the rim of the female connecting base overlaps the clamp of the male connecting base in the normal direction of the second surface.

At least in one embodiment of the disclosure, the connecting device further includes a plurality of fasten components, and the structural board is fastened to the second surface of the female connecting base through the plurality of fasten components.

At least in one embodiment of the disclosure, a structural strength of the structural board is larger than a structural strength of the rim of the female connecting base.

At least in one embodiment of the disclosure, the structural board is spaced from the terminals.

At least in one embodiment of the disclosure, a spacing between the terminals is larger than 6 mm.

Another embodiment of the disclosure provides a lamp including the connecting device, a terminal block board disposed on the female connecting base of the connecting device, where the ground strip of the male connecting base used for being connected to the terminal block board. A lamp body is disposed on the male connecting base of the connecting device, and the lamp body is electrically connected to the connecting device through the conductive strips of the male connecting base.

At least in one embodiment of the disclosure, when the male connecting base is fastened to the female connecting base, the ground surface of the ground strip presses a surface of the terminal block board and makes the ground strip elastically deformed.

Accordingly, the connecting device of this disclosure utilizes the female connecting base and the male connecting base to achieve quick connection with the power source and power consuming module and convenience of the installation. In addition, the prior grounding can also be achieved since the ground strip protrudes from the end surface of the conductive strips, thereby improving the safety during the installation.

### BRIEF DESCRIPTION OF THE DRAWINGS

To illustrate more clearly the aforementioned and the other objects, features, merits, and embodiments of the present disclosure, the description of the accompanying figures are as follows:

FIG. 1 illustrates a stereographically cross-sectional view of a connecting device in accordance with at least one embodiment of the present disclosure.

FIG. 2A illustrates a stereographical view of a female connecting base in accordance with at least one embodiment of the present disclosure.

FIG. 2B illustrates a locally-top view of a connecting device in accordance with at least one embodiment of the present disclosure.

FIG. 3 illustrates a stereographical view of a female connecting base in accordance with at least one embodiment of the present disclosure.

FIG. 4 illustrates a stereographical view of a male connecting base in accordance with at least one embodiment of the present disclosure.

FIG. 5 illustrates a stereographical view of a lamp in accordance with at least one embodiment of the present disclosure.

### DETAILED DESCRIPTION

In the following description, the dimensions (such as lengths, widths and thicknesses) of components (such as layers, films, substrates and regions) in the drawings are enlarged not-to-scale, and the number of components may be reduced in order to clarify the technical features of the disclosure. Therefore, the following illustrations and explanations are not limited to the number of components, the number of components, the dimensions and the shapes of components, and the deviation of size and shape caused by the practical procedures or tolerances are included. For example, a flat surface shown in drawings may have rough and/or non-linear features, while angles shown in drawings may be circular. As a result, the drawings of components shown in the disclosure are mainly for illustration and not intended to accurately depict the real shapes of the components, nor are intended to limit the scope of the claimed content of the disclosure.

Further, when a number or a range of numbers is described with “about,” “approximate,” “substantially,” and the like, the term is intended to encompass numbers that are within a reasonable range considering variations that inherently arise during manufacturing as understood by one of ordinary skill in the art. In addition, the number or range of numbers encompasses a reasonable range including the number described, such as within +/−5%, +/−3% or +/−1% of the number described, based on known manufacturing tolerances associated with manufacturing a feature having a characteristic associated with the number. The words of deviations such as “about,” “approximate,” “substantially,” and the like are chosen in accordance with the optical properties, etching properties, mechanical properties or other properties. The words of deviations used in the optical properties, etching properties, mechanical properties or other properties are not chosen with a single standard.

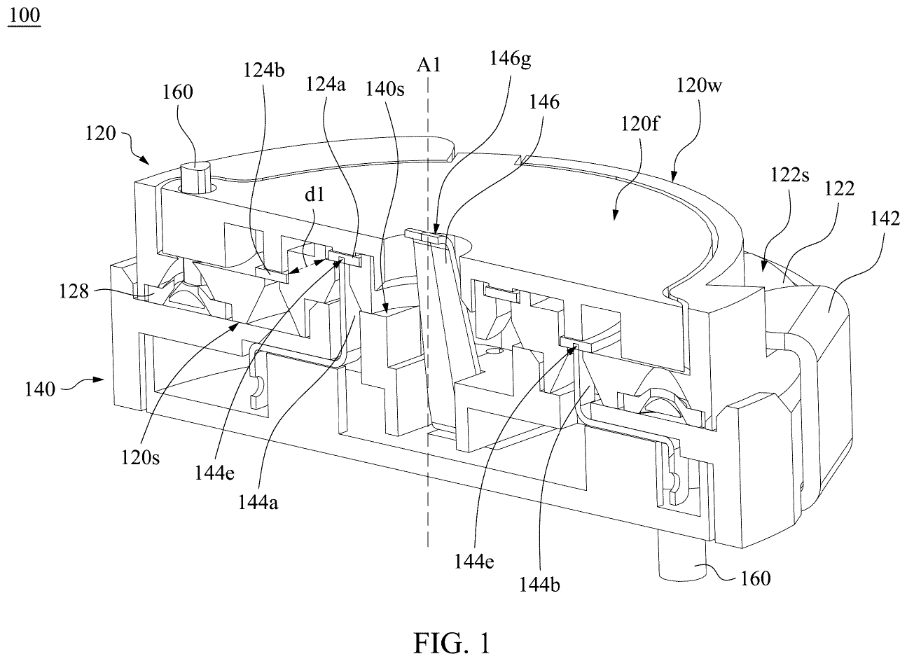

Referring to FIG. 1, a connecting device 100 of the present disclosure may electrically connect a power source with a power consuming module. For instance, the connecting device 100 can be used for connecting the power consuming module, such as lamp or ceiling fan to the electric supply. That is, the aforementioned power consuming module is connected to the power cable of the electric supply on the ceiling in the building, so that the power consuming module works (e.g. the lamp lights up).

The connecting device 100 includes a female connecting base 120 and a male connecting base 140. As shown in FIG. 1, the female connecting base 120 has a first surface 120f and a second surface 120s opposite to each other and includes a rim 122 and two terminals: the terminal 124a and the terminal 124b. The rim 122 of the female connecting base 120 is disposed on the first surface 120f. The terminal 124a and the terminal 124b are used for connecting to the live wire and the neutral wire (not shown) of the power source (e.g. electric supply) separately, and the terminal 124a and the terminal 124b are exposed on the second surface 120s or the female connecting base 120.

The male connecting base 140 includes a clamp 142, two conductive strips: the conductive strip 144a and the conductive strip 144b, and a ground strip 146. The conductive strip 144a and the conductive strip 144b of the male connecting base 140 are used for connecting to the terminal 124a and the terminal 124b of the female connecting base 120 separately. Further, an end surface 144e of each conductive strip (i.e. the conductive strip 144a and the conductive strip 144b) protrudes from a third surface 140s of the male connecting base 140. In addition, the ground strip 146 of the male connecting base 140 includes a ground surface 146g, while the ground surface 146g protrudes from the end surfaces 144e of the conductive strip 144a and the conductive strip 144b. In other words, the height which the ground surface 146g is beyond the third surface 140s is larger than the height which the end surface 144e beyond the third surface 140s. According to this design, during the process of rotary buckling of the male connecting base 140 to the female connecting base 120, the ground strip 146 will protrude from the first surface 120f of the female connecting base 120 before the conductive strips (i.e. the conductive strip 144a and the conductive strip 144b) touch the terminals (i.e. the terminal 124a and the terminal 124b). As a result, the ground strip 146 will touch a conductive objective (e.g. a metal terminal block board) except for the connecting device 100 before the conductive strip 144a and the conductive strip 144b touch the terminal 124a and the terminal 124b, so that the grounding effect is achieved. Thus, this design of the connecting device 100 is advantage for grounding.

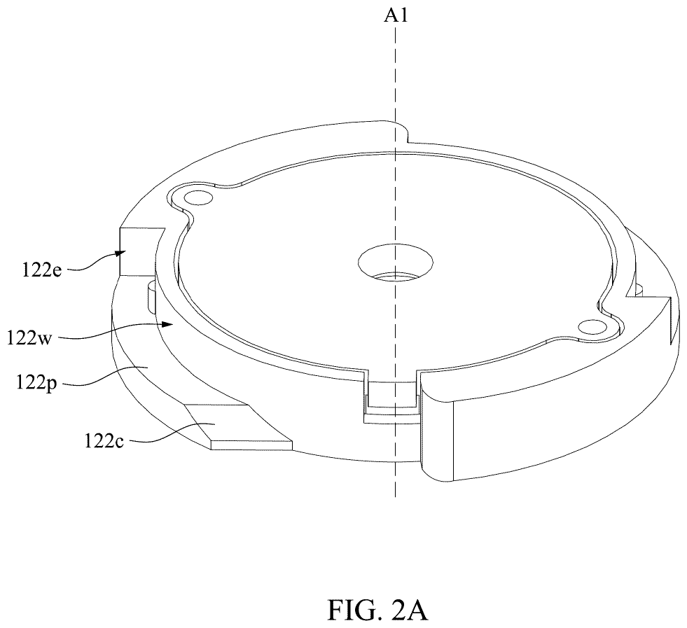

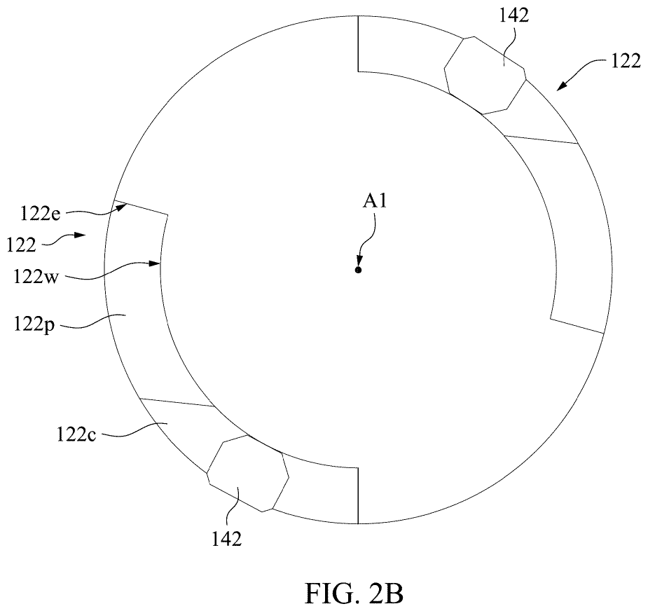

Referring to FIG. 1, FIG. 2A and FIG. 2B, a surface 122s of the rim 122 caves in the first surface 120f and extends along a side wall 120w of the female connecting base 120. The clamp 142 of the male connecting base 140 is used for clamping the rim 122, so that the third surface 140s of the male connecting base 140 faces to the second surface 120s of the female connecting base 120 and is fastened to the female connecting base 120.

It is worth mentioning, the clamp 142 clamps on the rim 122 with rotary bucking in this embodiment. Specifically, the clamp 142 is aligned to a slope region 122c of the rim 122 after the third surface 140s of the male connecting base 140 is connected to the second surface 120s of the female connecting base 120. Afterwards, the male connecting base 140 is rotated relative to the female connecting base 120 by a central axis A1. Thus, the clamp 142 is moved along with the side wall 120w of the female connecting base 120 from the slope region 122c to a plane region 122p of the rim 122, and then is stopped at an end surface 122e of the rim 122.

Base on the top view of FIG. 2B, the female connecting base 120 includes two rims 122 which are separately located on two opposite ends of the first surface 120f (shown in FIG. 1) in the embodiment (i.e. two ends are 180 degree apart). The male connecting base 140 also includes two clamps 142 which are separately located on two opposite ends of the third surface 140s. This design can prevent two ends of the connecting device 100 from being unevenly stressed during the process of rotary buckling, and thus increase the strength of buckling. However, in other embodiments, the number of the rim 122 and the clamp 142 are not limited to be two, but can be any number above one, such as three.

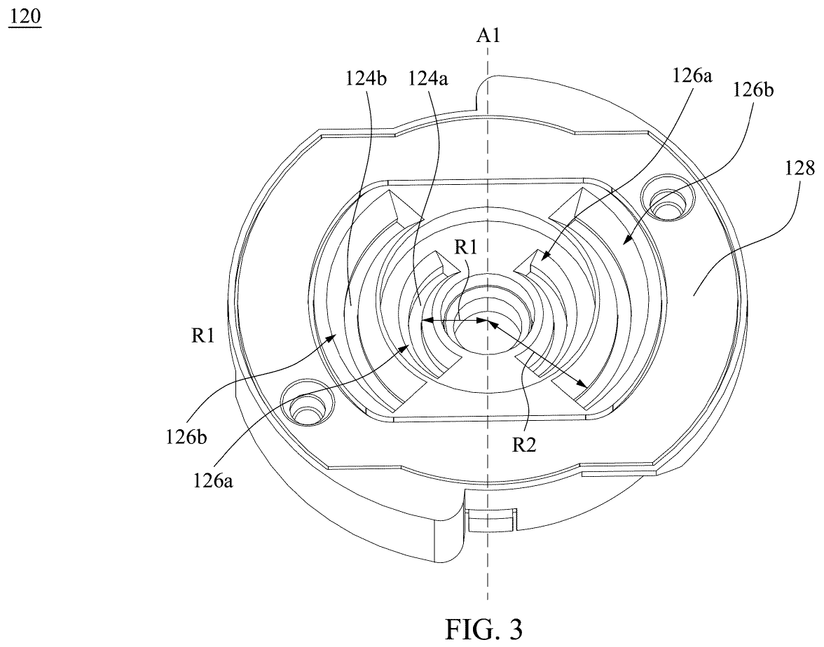

Referring to FIG. 3, the female connecting base 120 further includes two opposite first arc recesses 126a and two opposite second arc recesses 126b, while the first arc recesses 126a and second arc recesses 126b are located on the second surface 120s. The terminal 124a of the female connecting base 120 is exposed on a bottom surface (not denoted) of the first arc recesses 126a, and the terminal 124b is exposed on a bottom surface of the second arc recesses 126b (not denoted).

It is worth mentioning, the first arc recesses 126a and the second arc recesses 126b are concentric circular arcs, and an arc radius R1 of the first arc recesses 126a and is different from an arc radius R2 of the second arc recesses 126b. For instance, the arc radius R1 of the first arc recesses 126a may be smaller than the arc radius R2 of the second arc recesses 126b. In other words, the first arc recesses 126a are nearer to the central axis A1 compared to the second arc recesses 126b.

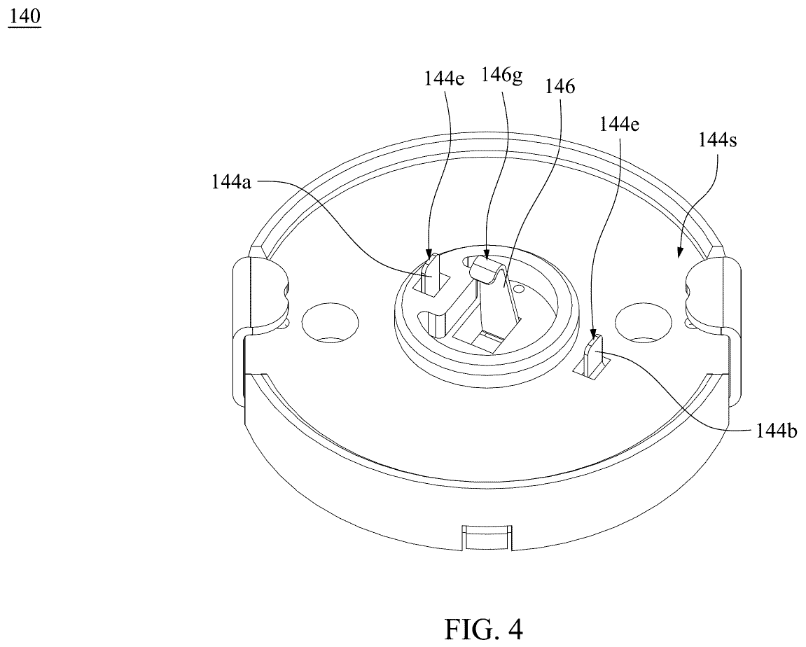

Referring to FIG. 1 and FIG. 4, in order to operate the rotary buckling of the female connecting base 120 to the male connecting base 140, an arc length (not denoted) of the rim 122 extends along an arc length of the first arc recesses 126a. As a result, when the female connecting base 120 is rotary buckled to the male connecting base 140, the conductive strip 144a of the male connecting base 140 may move along the arc length of the first arc recesses 126a without blocking by the side wall of the first arc recesses 126a.

Referring to FIG. 4, the end surface 144e protrudes from the third surface 140s, and the terminal 124a and the terminal 124b are separately exposed on the bottom surfaces of the first arc recesses 126a and the second arc recesses 126b. Thus, when the male connecting base 140 is fastened to the female connecting base 120, the conductive strips of the male connecting base 140 may be connected to the terminals of the female connecting base 120 within the first arc recesses 126a and the second arc recesses 126b. Specifically, the conductive strip 144a and the terminal 124a are connected to each other within one of the first arc recesses 126a, while the conductive strip 144b and the terminal 124b are connected to each other within one of the second arc recesses 126b. In the other embodiment, the terminal 124a and the terminal 124b are separately located in the first arc recesses 126a and the second arc recesses 126b which are located at different altitudes, so that a longer trace spacing causing by the altitude difference between the two terminals, thereby improving the safety for electricity.

In general, the terminal block components (e.g. the terminal block boards) of the lamps (or similar electrical appliances) are located on the first surface 120f of the female connecting base 120. Thus, the ground strip 146 directly touches and is electrically connected to the ground end once the ground strip 146 protrudes from the female connecting base 120, and then the priority of grounding is achieved, thereby improving the safety during the installation.

In this embodiment, the materials of the rim 122 of the female connecting base 120 may include poly butylene terephthalate (PBT), glass fibers or other similarity for strength enhancement, but the disclosure is not limited to the embodiment. Furthermore, the rim 122 may be produced by injection molding. Thus, the structural strength of the rim 122 may be limited by the mechanical strengths (e.g. tensile strength) of those aforementioned materials.

In order to enhance the structural strength of the connecting device 100, the female connecting base 120 further includes a structural board 128 (shown in FIG. 1 and FIG. 3), and the structural strength of the structural board 128 is larger than the structural strength of the rim 122 of the female connecting base 120. In the same way, the structural strength of the clamp 142 is larger than the structural strength of the main body of the male connecting base 140. For instance, the materials of the structural board 128 and the clamp 142 may include such as stainless steel or similar alloys. Since the structural strength of the structural board 128 and the clamp 142 is larger than the structural strength of the rim 122 and the main body of the male connecting base 140, the load-bearing capacity of the connecting device 100 in the normal direction is increased.

As shown in FIG. 1, the structural board 128 is located on the second surface 120s and overlaps the rim 122 in the normal direction of the second surface 120s (not demoted due to overlap of the central axis A1). When the male connecting base 140 is fastened to the female connecting base 120, the rim 122 of the female connecting base 120 overlaps the clamp 142 of the male connecting base 140 in the normal direction of the second surface 120s. In general, the load-bearing direction of the connecting device 100 extends along the normal direction of the second surface 120s. Therefore, the load-bearing capacity of the connecting device 100 may be increased by disposing the structural board 128 in the aforementioned manner. To take the connecting device 100 of this embodiment for example, the load-bearing capacity may be increased by disposing the structural board 128 on the connecting device 100. The structural board 128 of one embodiment is a metal board made from iron or stainless steel, and the clamp 142 may also be a metal board made from iron or stainless steel. Compared to those prior ceiling lamps whose load-bearing structures are made from plastics, the structural board 128 or the clamp 142 in the embodiments will not suffer from safety issues such as embrittlement and collapse. For instance, in this embodiment, the female connecting base 120 can be formed on the outside of the structural board 128 by plastic injection, and the main body of the male connecting base 140 can also be formed by plastic injection, so that the clamp 142 can be combined with the surface of the main body of the male connecting base 140.

In addition, the connecting device 100 further includes a plurality of fasten components 160, and the structural board 128 is fastened to the second surface 120s of the female connecting base 120 through these fasten components 160. The clamp 142 may be fastened to the male connecting base 140 through the fasten components 160. Specifically, the fasten components 160 may be such as the screws or similarities. In order to increase the structural strength of the junction between the structural board 128 and the second surface 120s, the materials of the fasten components 160 may include the alloys such as the stainless steels.

It is worth mentioning, the structural board 128 is spaced from the terminal 124a and the terminal 124b, so that the structural board 128 is prevented from short circuit due to being electrically connected to the terminal 124a or the terminal 124b. The terminal 124a and the terminal 124b are used for connecting to the live wire and the neutral wire of the power source separately. Thus, a spacing between the terminal 124a and the terminal 124b is larger than 6 mm in order to prevent the terminal 124a from touching the terminal 124b which causes the short circuit. Specifically, referring to FIG. 1, the shortest distance d1 between the terminal 124a and the terminal 124b should be larger than 6 mm.

Compared to prior connecting device, the male connecting base 140 of the disclosure is rotary fastened to the female connecting base 120 by the rim 122 and the clamp 142, so that to simplify the installation of the connecting device 100. Moreover, the structural board 128 and the fasten components 160 may increase the structural strength of the connecting device 100, thereby increasing the maximal load-bearing capability of the connecting device 100.

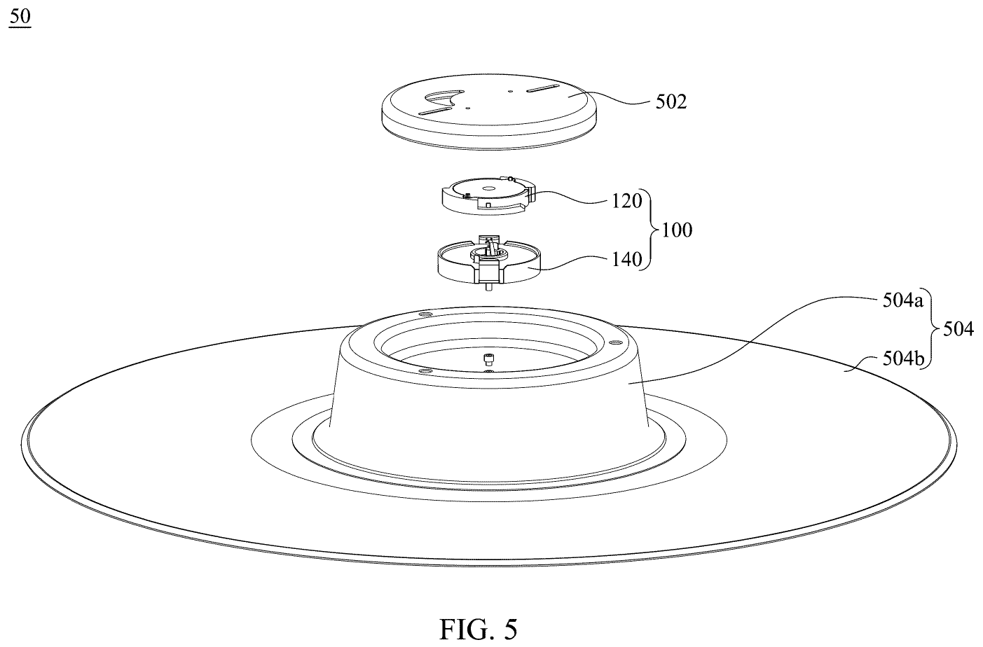

Referring to FIG. 5, the other embodiment of the disclosure includes the connecting device 100, a terminal block board 502 and a lamp body 504. The terminal block board 502 is disposed on the female connecting base 120 of the connecting device 100, and the ground strip 146 of the male connecting base 140 is used for electrically connecting to the terminal block board 502. The lamp body 504 is disposed on the male connecting base 140 of the connecting device 100, and the lamp body 504 is electrically connected to the connecting device 100 through the conductive strip 144a and the conductive strip 144b. In the embodiment, the lamp body 504 is the aforementioned power consuming module. For instance, the lamp body 504 of this disclosure may include a lamp holder 504a and a light guide plate 504b, while the lamp holder 504a is located at the central area of the light guide plate 504b, and the male connecting base 140 is located at the central area of the lamp holder 504a. The installation of the lamp 50 can be achieved by relative rotation and the connection between the female connecting base 120 and the male connecting base 140 of the connecting device 100, so that the installation is more convenient.

Referring to FIG. 1 and FIG. 5, when the male connecting base 140 is fastened to the female connecting base 120, the ground surface 146g of the ground strip 146 presses the surface (not denoted) of the terminal block board 502, so that the ground strip 146 is elastically deformed due to the elasticity of the ground strip 146. In the embodiment, the first surface 120f or the female connecting base 120 may touch the surface of the terminal block board 502. Thus, when the ground surface 146g of the ground strip 146 presses the surface of the terminal block board 502 and makes the ground strip 146 elastically deformed, the ground surface 146g will flush with the first surface 120f of the female connecting base 120. Therefore, during the process of relative rotation between the male connecting base 140 and the female connecting base 120 while the lamp body 504 is disposed on the terminal block board 502, the ground strip 146 will continuously touch the surface of the terminal block board 502 for the grounding and the safety. Further, based on the characteristic of the elastic deformation, the conductive strip 144a and the conductive strip 144b are pressed on the terminal 124a and the terminal 124b for ensuring the energization.

In conclusion, since the ground surface of the ground strip of the connecting device protrudes from the end surfaces of the conductive strips, the ground strip of the male connecting base will touch the ground end of the terminal block component prior to other components and to achieve the grounding effect during the installation of the lamp. Afterwards, the conductive strips of the male connecting base will touch the terminal of the female connecting base to energize the lamps. Therefore, the grounding can be ensured before the energization of the lamp, and thus the safety for installation is improved.

Furthermore, the structural board is disposed on the connecting device, and the structural board overlaps the rim in the normal direction of the second surface of the female connecting base. When the male connecting base is fastened to the female connecting base, the clamp will overlap the structural board in the normal direction of the second surface.

Although the embodiments of the present disclosure have been disclosed as above in the embodiments, they are not intended to limit the embodiments of the present disclosure. Any person having ordinary skill in the art can make various changes and modifications without departing from the spirit and the scope of the embodiments of the present disclosure. Therefore, the protection scope of the embodiments of the present disclosure should be determined according to the scope of the appended claims.

What is claimed is:

1. A connecting device used for electrically connecting a power source with a power consuming module, comprising:
a female connecting base having a first surface and a second surface opposite to each other, comprising:
a rim disposed on the first surface; and
two terminals used for separately connecting to a live wire and a neutral wire of the power source, wherein the terminals are exposed on the second surface of the female connecting base; and
a male connecting base, comprising:
a clamp used for clamping the rim, wherein a third surface of the male connecting base faces to the second surface of the female connecting base and is fastened to the female connecting base;
two conductive strips used for connecting to the terminals of the female connecting base separately, wherein an end surface of each of the conductive strips protrudes from the third surface of the male connecting base; and
a ground strip including a ground surface, wherein the ground surface protrudes from the end surfaces of the conductive strips.

2. The connecting device of claim 1, wherein the female connecting base further comprises:
two first arc recesses opposite to each other and disposed on the second surface, wherein one of the terminals is exposed on a bottom surface of the first arc recesses; and
two second arc recesses opposite to each other and disposed on the second surface, wherein the other one of the terminals is exposed on a bottom surface of the second arc recesses;
wherein the first arc recesses and the second arc recesses are concentric circular arcs, and an arc radius of the second arc recesses is different from an arc radius of the first arc recesses,
wherein when the male connecting base is fastened to the female connecting base, the conductive strips of the male connecting base is connected with the terminals of the female connecting base within the first arc recesses and the second arc recesses.

3. The connecting device of claim 2, wherein an arc length of the rim extends along an arc length of the first arc recesses.

4. The connecting device of claim 1, wherein the female connecting base further comprises:
a structural board located on the second surface and overlapping the rim in the normal direction of the second surface, wherein when the male connecting base is fastened to the female connecting base, the rim of the female connecting base overlaps the clamp of the male connecting base in the normal direction of the second surface.

5. The connecting device of claim 4, further comprising:
a plurality of fasten components, wherein the structural board is fastened to the second surface of the female connecting base through the plurality of fasten components.

6. The connecting device of claim 4, wherein a structural strength of the structural board is larger than a structural strength of the rim of the female connecting base.

7. The connecting device of claim 4, wherein the structural board is spaced from the terminals.

8. The connecting device of claim 1, wherein a spacing between the terminals is larger than 6 mm.

9. A lamp, comprising:
the connecting device of claim 1;
a terminal block board disposed on the female connecting base of the connecting device, wherein the ground strip of the male connecting base used for being connected to the terminal block board; and
a lamp body disposed on the male connecting base of the connecting device, wherein the lamp body is electrically connected to the connecting device through the conductive strips of the male connecting base.

10. The lamp of claim 9, wherein when the male connecting base is fastened to the female connecting base, the ground surface of the ground strip presses a surface of the terminal block board and makes the ground strip elastically deformed.

11. The lamp of claim 9, wherein the female connecting base further comprises:
two first arc recesses opposite to each other and disposed on the second surface, wherein one of the terminals is exposed on a bottom surface of the first arc recesses; and
two second arc recesses opposite to each other and disposed on the second surface, wherein the other one of the terminals is exposed on a bottom surface of the second arc recesses;
wherein the first arc recesses and the second arc recesses are concentric circular arcs, and an arc radius of the second arc recesses is different from an arc radius of the first arc recesses,
wherein when the male connecting base is fastened to the female connecting base, the conductive strips of the male connecting base is connected with the terminals of the female connecting base within the first arc recesses and the second arc recesses.

12. The lamp of claim 11, wherein an arc length of the rim extends along an arc length of the first arc recesses.

13. The lamp of claim 9, wherein the female connecting base further comprises:
a structural board located on the second surface and overlapping the rim in the normal direction of the second surface, wherein when the male connecting base is fastened to the female connecting base, the rim of the female connecting base overlaps the clamp of the male connecting base in the normal direction of the second surface.

14. The lamp of claim 13, wherein the connecting device further comprising:
a plurality of fasten components, wherein the structural board is fastened to the second surface of the female connecting base through the plurality of fasten components.

15. The lamp of claim 13, wherein a structural strength of the structural board is larger than a structural strength of the rim of the female connecting base.
